(19) United States
(12) Patent Application Publication
(10) Pub. No.: US 2025/0160381 A1
(43) Pub. Date: May 22, 2025

(54) A PLANT-ONLY ANTI-FREEZING AND ANTI-CAKING SYSTEM FOR FOOD PRODUCTS AND METHODS OF PREPARATION THEREOF

(71) Applicant: The Live Green Group, Inc., Middletown, DE (US)

(72) Inventors: Sasikanth Chemalamudi, San Fernando (CL); Priyanka Srinivas, San Fernando (CL)

(73) Assignee: The Live Green Group, Inc., Middletown, DE (US)

(21) Appl. No.: 18/840,988

(22) PCT Filed: Feb. 22, 2023
(86) PCT No.: PCT/IB2023/051613

§ 371 Date: Aug. 23, 2024

(30) Foreign Application Priority Data
Feb. 28, 2022 (US) 63314775

(51) Int. Cl. A23L 33/11; A23L 19/00; A23L 33/12; A23L 33/125; A23L 33/24

(52) U.S. Cl. CPC A23L 33/11; A23L 19/09; A23L 33/12; A23L 33/125; A23L 33/24

(57) ABSTRACT

A plant-only anti-freezing and anti-caking system for a plant-only food product is provided. The plant-only anti-freezing and anti-caking system is produced by blending one or more plant-derived category of ingredients such as a plant-derived source of fat, a fruit puree, a source of lignin and cellulose fiber, a source of vegetable phytosterols and PUFAs (including omega-3 fatty acids), a source of lauric acid, (a medium-chain fatty acid), and one or more sugars and/or sugar replacements in a blender to obtain a first homogeneous mixture. The first homogeneous mixture is pasteurized by continuous mixing for about 15-30 minutes at a temperature of 68-75 degrees Celsius to obtain the plant-only anti-freezing and anti-caking system. The anti-freezing and anti-caking system is used individually or in a frozen food product (e.g., a frozen plant-only dessert product such as ice cream) along with one or more other plant-derived ingredients or systems.

### CROSS-REFERENCE TO RELATED APPLICATIONS

This application claims priority to the U.S. Provisional Application No. 63/314,775, filed Feb. 28, 2022, and PCT Provisional Patent Application No. PCT/IB2023/051613, filed Feb. 22, 2023, titled “A PLANT-ONLY ANTI-FREEZING AND ANTI-CAKING SYSTEM FOR FOOD PRODUCTS AND METHODS OF PREPARATION THEREOF” and is incorporated herein by reference.

### BACKGROUND

### Technical Field

The disclosed embodiment relates generally to food composition and, more particularly, to plant-only anti-freezing and anti-caking system for food products that replace synthetic or artificial food additives, such as those used in frozen dessert food products.

### Description of the Related Art

Many conventional food products and food dessert products, contain natural or synthetic food additives to serve as stabilizers, preservatives, sweeteners, and emulsifiers (e.g., for dairy products) to provide desired flavors, sweetening, textures, appearance, consistency and/or uniform blending or homogeneity to the food product when a number of different components or ingredients are combined to form the food product. Some examples of food additive sweeteners include acesulfame potassium, high fructose corn syrup, polysorbate 60/80, sucralose, and dextrose. Other example forms of food additives include silicon dioxide, sodium benzoate, sodium nitrite, artificial food color dyes, etc. Many such additives (particularly synthetic additives) can be harmful to some people if consumed over prolonged periods of time. The industry uses more than 7,000 synthetic and ultra-processed additives even though nature offers more than 10,000,000 compounds from more than 450,000 plants. Traditional anti-freezing and anti-caking additives used in the industry include, among others, guar gum, methylcellulose, polydextrose and mannitol.

In addition, many dessert products and frozen dessert products (e.g., ice cream, sherbet, frozen yogurt, etc.), tend to contain dairy and/or eggs, which can be undesirable for some people (e.g., to some who are lactose intolerant or have a milk or dairy allergy). For people interested in a plant-based or vegan diet, this limits the variety of available dessert products on the market.

It would be desirable to provide a non-dairy dessert or other non-dairy food product that is plant-only and minimizes or avoids the use of anti-freezing and anti-caking additives outside of a plant genus while ensuring desirable flavor, texture, appearance, and taste.

### SUMMARY

A plant-only anti-freezing and anti-caking system for a plant-only food product is provided. The plant-only anti-freezing and anti-caking system comprising one or more plant-derived category of ingredients such as a plant-only source of fat, a fruit puree, a source of lignin and cellulose fiber, a source of vegetable phytosterols and PUFAs (including omega-3 fatty acids), a source of lauric acid, (a medium-chain fatty acid), and one or more sugars and/or sugar replacements.

According to an aspect of the disclosed embodiments, a plant-only anti-freezing and anti-caking system for food products is provided. The composition includes a) 5.0-25% by weight of a fat source, b) 5-20% by weight of a fruit puree source, c) 5.0-25% by weight of a lignin & cellulose source, d) 5.0-25% by weight of a vegetable phytosterols & PUFA source, e) 5-25% by weight of a PUFA & Omega-3-Fatty acid source, f) 3-20% by weight of a Lauric acid source, and g) 5-25% by weight of a sugars and/or sugar replacement source.

According to an embodiment, the fat source is selected from Avocado, sunflower oil, olive oil, mango kernel fat, Peanut, oil, palm kernel oil, soybean oil, safflower oil, cocoa butter, corn oil, flaxseed oil, sesame oil or similar/combinations thereof.

According to another embodiment, the fruit puree source is selected from custard apple puree, banana puree, apple puree, avocado puree, pear puree, muskmelon puree, papaya puree, prunes puree, apricot, mango puree, dragon fruit puree or similar/combinations thereof.

According to yet another embodiment, the lignin & cellulose source is selected from Sugar beet, Peaches, oat bran, artichoke, chicory root, quinoa, peas, navy beans, white beans and adzuki beans or similar/combinations thereof.

According to yet another embodiment, the vegetable phytosterols & PUFA source is selected from Sunflower oil, soybean oil, peas, sesame oil, kidney beans, almonds, olive oil, pistachios, pecans, walnuts, corn oil or similar/combinations thereof.

According to yet another embodiment, the PUFA & Omega-3-Fatty acid source is selected from Flaxseed Oil, chia seeds, hemp seeds, walnuts, kidney beans, wheat germ, butternut, red currant seeds, black currant seeds, pumpkin seeds, purslane or similar/combinations thereof.

According to yet another embodiment, the lauric acid source is selected from Coconut cream, bay laurel berry kernel, palm kernel oil, babassu Oil, cohune oil, macadamia nuts, cashews, peanuts, star anise seed oil, Mucajá nut or similar/combinations thereof.

According to yet another embodiment, the sugars and/or sugar replacement source is selected from monk fruit powder, Banana, maple syrup, Custard apple, Raisins, Durian, Pears, Prunes, Sapodilla, Agave, Dried apricots, Date palm, Mangosteen, Barhi dates or similar/combinations thereof.

According to yet another embodiment, the food product is a frozen dessert product, shredded cheese, milk and cream powder, flour-based mix, cocoa and mixed coffee beverage, frozen dough, and frozen noodles.

According to yet another aspect of the disclosed embodiments, a method of preparing a plant-only anti-freezing and anti-caking system for food products is provided. The method includes (i) mixing a) 5.0-25% by weight of a fat source, b) 5-20% by weight of a fruit puree source, c) 5.0-25% by weight of a lignin & cellulose source, d) 5.0-25% by weight of a vegetable phytosterols & PUFA source, e) 5-25% by weight of a PUFA & Omega-3-Fatty acid source, f) 3-20% by weight of a Lauric acid source, and g) 5-25% by weight of a sugars and/or sugar replacement source in a blender at an RPM of 18000 to 28000 RPM, to obtain a first homogeneous mixture, and (ii) pasteurizing the first homogeneous mixture by continuous mixing for about 15 to 30 minutes and at a temperature of 68 to 75 degrees Celsius to obtain the plant-only anti-freezing and anti-caking system for food products.

According to an embodiment, the fat source is selected from Avocado, sunflower oil, olive oil, mango kernel fat, Peanut, oil, palm kernel oil, soybean oil, safflower oil, cocoa butter, corn oil, flaxseed oil, sesame oil or similar/combinations thereof.

According to another embodiment, the fruit puree source is selected from custard apple puree, banana puree, apple puree, avocado puree, pear puree, muskmelon puree, papaya puree, prunes puree, apricot, mango puree, dragon fruit puree or similar/combinations thereof.

According to yet another embodiment, the lignin & cellulose source is selected from Sugar beet, Peaches, oat bran, artichoke, chicory root, quinoa, peas, navy beans, white beans and adzuki beans or similar/combinations thereof.

According to yet another embodiment, the vegetable phytosterols & PUFA source is selected from Sunflower oil, soybean oil, peas, sesame oil, kidney beans, almonds, olive oil, pistachios, pecans, walnuts, corn oil or similar/combinations thereof.

According to yet another embodiment, the PUFA & Omega-3-Fatty acid source is selected from Flaxseed Oil, chia seeds, hemp seeds, walnuts, kidney beans, wheat germ, butternut, red currant seeds, black currant seeds, pumpkin seeds, purslane or similar/combinations thereof.

According to yet another embodiment, the lauric acid source is selected from Coconut cream, bay laurel berry kernel, palm kernel oil, babassu Oil, cohune oil, macadamia nuts, cashews, peanuts, star anise seed oil, Mucajá nut or similar/combinations thereof.

According to yet another embodiment, the sugars and/or sugar replacement source is selected from monk fruit powder, Banana, maple syrup, Custard apple, Raisins, Durian, Pears, Prunes, Sapodilla, Agave, Dried apricots, Date palm, Mangosteen, Barhi dates or similar/combinations thereof.

According to yet another embodiment, the food product is a frozen dessert product, shredded cheese, milk and cream powder, flour-based mix, cocoa and mixed coffee beverage, frozen dough, and frozen noodles.

According to yet another embodiment, physical characterization data associated with the ingredients of the anti-freezing and anti-caking system comprising the fat source, the fruit puree source, the lignin & cellulose source, the vegetable phytosterols & PUFA source, the PUFA & Omega-3-Fatty acid source, the Lauric acid source, and the sugars and/or sugar replacement source is stored in a database, wherein a machine learning model determines a unique combination of ingredients based on the physical characterization data to prepare the anti-freezing and anti-caking system.

According to yet another embodiment, the physical characterization data of the ingredients comprise functional properties that comprise emulsification properties, stabilization properties, gelling properties, fat-replacement properties, ayurvedic and/or other holistic properties, physicochemical properties that comprise pH, viscosity, moisture content, density, mechanical properties that comprise adhesive strength, tensile strength, shear resistance, chemical and/or molecular descriptor properties that comprise bio-active/bioavailability properties, molecular structure, phytonutrient properties, sensorial properties that comprise taste, smell, color, texture, mouth feel, and nutritional information that comprises macronutrient/micronutrient properties.

Several aspects of the disclosed embodiments are described below with reference to examples for illustration. However, one skilled in the relevant art will recognize that the disclosed embodiments can be practiced without one or more of the specific details or with other methods, components, materials, and so forth. In other instances, well-known structures, materials, or operations are not shown in detail to avoid obscuring the features of the disclosed embodiments. Furthermore, the features/aspects described can be practiced in various combinations, though only some of the combinations are described herein for conciseness.

### BRIEF DESCRIPTION OF THE DRAWINGS

Example embodiments of the disclosed embodiments will be described with reference to the accompanying drawings briefly described below.

FIG. 1 illustrates a flow chart of a method of preparing a plant-only anti-freezing and anti-caking system for food products according to the aspect of the present disclosed embodiments.

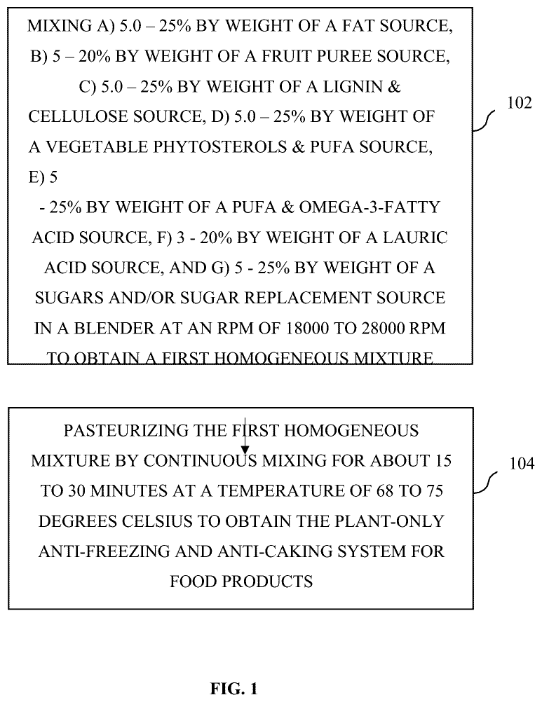

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE DISCLOSED EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another. Further, the terms “comprising,” “including,” “having,” and the like, as used with respect to embodiments of the present disclosure, are synonymous. As used herein, the terms “agent,” “component,” or “ingredient” are used interchangeably and refer to a particular item that includes one or more chemical compounds (e.g., a food item from one or more plants that comprise one or more naturally occurring chemical compounds).

The term “component” or “ingredient” as used herein, refers to a particular item that includes one or more chemical compounds, i.e., edible compounds sourced from plants, fungi or algae that comprises one or more naturally occurring chemical compounds.

Alternative embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

As used herein, the singular forms “a”, “an”, and “the” include both singular and plural referents unless the context clearly dictates otherwise. By way of example, “a dosage” refers to one or more than one dosage.

The terms “comprising”, “comprises” and “comprised of” as used herein are synonymous with “including”, “includes” or “containing”, “contains”, and are inclusive or open-ended and do not exclude additional, non-recited members, elements or method steps.

All documents cited in the present specification are hereby incorporated by reference in their totality. In particular, the teachings of all documents herein specifically referred to are incorporated by reference.

Example embodiments of the disclosed embodiments are described with reference to the accompanying FIGURES.

In the drawings, like reference numbers generally indicate identical, functionally similar, and/or structurally similar elements. The drawing in which an element first appears is indicated by the leftmost digit(s) in the corresponding reference number.

### Definitions

“anti-freezing” refers to lowering freezing point and achieving the freezing-point depression for cold environments.

“anti-caking” refers to prevention of particles from caking together and to ensure the product remains dry and free-flowing.

“Fat” refers to a type of lipid consisting of triesters of glycerol and fatty acids or triglycerides.

“Fruit puree” refers to making fruit or vegetables into a thick, smooth sauce by crushing.

“Lignin” refers to an organic polymer present in cell walls.

“cellulose” refers to a complex carbohydrate that is the chief part of the cell walls of plants.

“phytosterols” refers to Phyto steroids, similar to cholesterol, that serve as structural components of biological membranes of plants.

“Polyunsaturated fats” are fats in which the constituent hydrocarbon chain possesses two or more carbon-carbon double bonds.

“Omega-3 fatty acids” refers to a form of polyunsaturated fat that the body derives from food.

“Lauric Acid” refers to a saturated medium-chain fatty acid found naturally in various plant.

“Derived sugars” refers to modified monosaccharides.

“Emulsifier” refers to an additive used to help mix two substances that typically separate when they are combined.

“Thickener” refers to a substance that increases the viscosity of a liquid without substantially changing its other properties.

“Stabilizer” refers to an additive to food that helps to preserve its structure.

“Flavoring agent” refers to an additive that provides an additional taste or flavor.

“Pasteurization” refers to the partial sterilization of a product to make it safe for consumption and improve its keeping quality.

“Homogeneous mixture” refers to a mixture that has the same proportions of its components throughout a given sample.

“Blender” refers to an appliance used to mix, crush, purée or emulsify food and other substances.

“Machine learning model” refers to computer software designed to recognize patterns or behaviors based on previous experience or data.

“Plant-derived” refers to ingredients extracted from a plant.

“Plant-only” products disclosed herein, as opposed to products labeled as “plant-based,” and the like, refer to food products whose ingredients, apart from any significant amount of water added, are derived solely from sources outside of the animal kingdom, e.g., from plants, fungi, or algae. That is, “plant-only” may refer to any formulation, composition, system or food product that is produced, developed, or otherwise obtained directly or indirectly from one or more plants, fungi, or algae, is not synthetic, and is only minimally processed for production, e.g., cleaned, dried, pulverized, etc.

The term “food product” refers broadly to any edible food or product, raw or cooked, savory or sweet, whether intended for human or animal consumption; a food product may be edible although not intended to be consumed on its own but, rather, incorporated into a second (or third) food product that is considered a consumable. In certain embodiments, while some of the water content of a food product may be derived from a plant source, water may also be added to the product from an external source. For example, in scenarios in which a plant-only system or plant-only food product is in the form of a gel or liquid, it is further understood that water can be included as solvent or liquid carrier for the plant-only system, ingredient or food product, where any amount of water (some or all) within the system, ingredient or food product may or may not be derived from a plant source. In the disclosed embodiments, apart from externally-sourced water, the plant-only food product consists entirely of ingredients derived from plants, fungi or algae, excluding any component or ingredient that is: (i) dairy-based or otherwise derived from any member of the animal kingdom; and (ii) more than minimally processed; and (ii) synthetic.

The Applicant, The Live Green Company, is the market maker of the Plant-only food product category, which means that all the animal, synthetic and ultra-processed ingredients are replaced by plant-derived ingredients with superior nutritional profiles without impacting the original organoleptic properties.

A “plant-only” food product or formulation that is free from dairy and other animal-based ingredients is described herein that has desirable flavor, taste, texture, homogeneity, consistency, color and appearance so as to be aesthetically pleasing prior to consumption. The terms “plant-derived” is used, in this disclosure to refer to any agent, ingredient, or component of a food product that is derived or extracted or obtained from plants with minimal processing. The term “plant-only” is used in this disclosure to refer to a system, composition or the entire food product itself, that is produced, developed or otherwise obtained directly or indirectly from one or more of the plant-derived ingredients that is obtained from plants with minimal processing. Although a plant-only system or food product may consist of materials that are 100 percent sourced from one or more plants, the term also encompasses systems and food products that may contain components or ingredients that are not obtained from plants. For example, while some of the water content of a food product may be derived from a plant source, water may also be added to the product from an external source. For example, in scenarios in which a plant-only system or plant only food product is in the form of a gel or liquid, it is further understood that water can be included as solvent or liquid carrier for the plant only system or plant only food product, where any amount of water (some or all) within the system or food product may or may not be derived from a plant source. In some embodiments, apart from added water, the plant-only food product consists entirely of (100%) of components or ingredients from a plant genus (i.e., photosynthetic eukaryotes from the kingdom Plantae), and further excluding any component or ingredient that is dairy-based, that is from the animal genus (including animal fats and animal proteins) and excludes any synthetically derived component or ingredient. The plant-derived ingredients of the food product described herein replace conventional animal-based ingredients, including milk, cream and eggs, as well as conventional additives such as gums, stabilizers, emulsifiers, preservatives, anti-freezing and anti-caking agents, binders, etc. The product formed solely from plant-derived ingredients is further free from gluten, soy, cholesterol and trans fatty acids.

The selection of specific plant-derived ingredients, or specific combinations (i.e., systems) of plant-derived ingredients provide effective functionalities such as emulsifiers, stabilizers, texturizing and thickening, fat replacement, sugars or other sweeteners, anti-freezing properties, anti-caking properties, etc., for the plant-only food product without the need to add such conventional, non-plant-derived additives. As used herein, the terms “agent,” “component,” or “ingredient” are used interchangeably and refer to a particular item that includes one or more chemical compounds (e.g., a food item from the plant species that comprises one or more naturally occurring chemical compounds). The term “plant-only”, as used herein, refers to a product or formulation (e.g., food product or food formulation).

### Functionality and Parameters

TABLE 1
Parameter ranges associated with ingredients of the
plant-only anti-freezing and anti-caking system.

| Functionalities | Parameters & Ranges | | | |
|---|---|---|---|---|
| Sugars or | Type of | Glycemic | Relative | Viscosity |
| sugar | carbohydrates/ | index | sweetness | Should |
| replacements | sweetener response: | Low GI: | with | be |
| | high intensity, longer | 1 to 55. | sucrose. | below |
| | time. | Medium GI: | | 600 cP |
| | | 56 to 69 | | |
| Plant only fat | HLB score: Veg. oils | Emulsion | Fat | |
| | should have 6 | stability: 30- | content: >16% | |
| | (required) | 70% | | |
| Fruit puree | Flow behavior index | Should be | | |
| | should be less than 1 | non- | | |
| | (i.e) shear thinning | newtonian | | |
| | (n < 1) | | | |
| Lignin & | Water | Swelling | Freezing | |
| Cellulose | absorption/retention | power: | point | |
| source(s) | capacity (WAC): 4-25 | 20.76-50% | depression | |
| [The | g/g or more. | | −3 to -5 C. | |
| parameters | | | | |
| taken are with | | | | |
| respect to | | | | |
| plant-only | | | | |
| fiber | | | | |
| functionality] | | | | |
| Vegetable | Water binding | Molecular | | |
| phytosterols | ability/Hydration | weight: >300 | | |
| PUFA | ability: | kDa | | |
| source(s) | | | | |
| [The parameters | 1600-3000 g of water/ | Higher | | |
| taken are with | 100 g of solids | preferred. | | |
| respect to the | Taken w.r.t. Flaxseed | | | |
| “plant only | oil | | | |
| anticaking and/or | | | | |
| anti freezing | | | | |
| agent.] | | | | |
| PUFA & | Water binding ability/ | Molecular | | |
| Omega-3- | Hydration ability: | weight: >300 | | |
| Fatty acid | 1600-3000 g of water/ | kDa | | |
| source(s) | 100 g of solids | Higher | | |
| [The | Taken w.r.t. Flaxseed | preferred. | | |
| parameters | oil | | | |
| taken are with | | | | |
| respect to the | | | | |
| functionality | | | | |
| of the | | | | |
| ingredient | | | | |
| within an anti- | | | | |
| caking and | | | | |
| anti-freezing | | | | |
| system.] | | | | |

The ingredients of the plant-only anti-freezing and anti-caking system may be selected for inclusion in a food product based on the ingredient's functionality, such as altering sugar content, increasing viscosity, increasing structural stability, increasing creamy texture, increasing the number of soluble fibers and protein, increasing healthy fats, increasing gelatinization, and increasing the water holding capacity. The ingredient is selected based on the ingredient's physicochemical properties, such as energy provided, melting, boiling, freezing and recrystallization points, physical phase, pH, viscosity, molecular weight, effects on overrun, viscosity, titratable acidity, and melting resistance.

The physical characterization data associated with the ingredients of the anti-freezing and anti-caking system is stored in a database. A machine learning model determines a unique combination of ingredients based on the physical characterization data to prepare the anti-freezing and anti-caking system. The machine learning model identifies plant-based ingredient replacements based on the parameters and ranges to give the list of ingredients for each possible functionality.

### Example Embodiments

The disclosed embodiments are illustrated in further detail by the following non-limiting examples.

TABLE 2
Percent by weight of each of the preferred, essential,
anti-freezing and anti-caking categories of ingredients
in the anti-freezing and anti-caking system.

| | Preferred Weight Percent of the |
|---|---|
| Preferred Anti-freezing and Anti- | System (based upon total |
| caking Ingredient Categories | weight of mixture) |
| Plant-only fat source(s) (e.g., | 5-25 |
| Avocado) | |
| Fruit puree source(s) (e.g., Custard | 5-20 |
| Apple, Banana) | |
| Lignin & Cellulose source(s) (e.g., | 5-25 |
| Sugar beet) | |
| Vegetable phytosterols & PUFA | 5-25 |
| source(s) (e.g., Sunflower oil) | |
| PUFA & Omega-3-Fatty acid | 5-25 |
| source(s) (e.g., Flaxseed Oil) | |
| Lauric acid source(s) (e.g., Coconut | 3-20 |
| cream) | |
| Sugars and/or Sugar replacement | 5-25 |
| source(s) (e.g., monk fruit powder) | |

A particularly effective combination of plant-derived ingredients in the anti-freezing and anti-caking category, including the ingredients forming the system as described herein, are combined as shown in Table 2 above, and form the anti-freezing and anti-caking system that may be, in whole or part, added to one or more other ingredients to form a plant-only ice cream or other frozen dessert. Together, two or more of the listed anti-freezing and anti-caking agents or their plant-derived equivalents comprise a combination of anti-freezing and anti-caking agents (i.e., an “anti-freezing and anti-caking system”).

Although Table 2 provides a preferred list of anti-freezing and anti-caking agents, substitutions for these agents in the system may be made in alternative embodiments for compliance with certain dietary requirements; without limitation, such as food sensitivities and food allergies. For example, peanut allergies would dictate a formulation free from peanuts (a type of legume) used as a fiber source so that an anaphylactic reaction would not be triggered by the consumer with such allergies. A second example would be a formulation containing low sugar but relatively higher content of a plant-derived, low-calorie, low-glycemic index sugar replacement, which may be indicated for diabetic diets.

TABLE 3
preferred composition in weight percentages of
the plant-derived ingredients or systems in a
final ice cream or frozen dessert food product.

| Food Product Component or | Preferred Weight Percent |
|---|---|
| System | Contribution |
| Water | 55%-65% |
| Bulking and texturizing system | 8%-10% |
| Sugars & Sugar replacements | 10%-15% |
| Fat replacement system | 2%-10% |
| Dairy replacement system | 5%-15% |
| Emulsifier & Stabilizer system | 0.5%-5% |
| Anti-Freezing & Anti Caking | 0.5%-5% |
| system | |

As seen from Table 3, the anti-freezing and anti-caking system disclosed herein preferably comprises only 0.5 to 5 percent of the final frozen dessert food product. Table 3 shows an embodiment of the preferred composition in weight percentages of the plant-derived ingredients or systems in the final ice cream or frozen dessert food product. Where individual ingredients are found in more than one system (e.g., sugar and sugar replacements are a separate component in Table 3, but also are found in the anti-freezing and anti-caking system and contribute to the range indicated for that system), the actual weight percent contribution of a particular ingredient (e.g., sugar) across all components or systems may not be evident from the data presented in Table 3.

In the disclosed embodiments, the anti-freezing and anti-caking system (which may vary by ingredients and amounts depending on the final food product desired) is incorporated into each food product embodiment, each ingredient or plant-derived system present (fat replacement systems, bulking and texturizing system, emulsifier and stabilizer system, dairy replacement systems, sugars and sugar replacements, and anti-freezing and anti-caking system) in an amount within the range(s) indicated in Tables 2 and 3. Additional ranges for the systems in Table 3 are detailed below.

In certain embodiments a food product is comprised of one or more plant-derived ingredients with anti-freezing and anti-caking functionality, wherein the anti-freezing and anti-caking ingredient of the system is selected from the group consisting of a sugar, banana, custard apple, avocado, sugar beet pulp, sunflower seed oil, flax seed oil, coconut cream, and a sugar replacement, where the ingredient is present in an amount by weight of the system according to Table 3 above. In certain other embodiments the food product is a frozen dessert product. In certain embodiments the food product is further comprised of one or more plant-derived ingredients or systems selected from the group consisting of a fat replacement system, a dairy replacement system, an emulsifier and stabilizer system, a bulking and texturizing system and a sugar and/or sugar replacement, as indicated in Table 3.

In other embodiments a frozen dessert food product comprises a mixture of two or more plant-derived ingredients that include sugar, banana, custard apple, avocado, sugar beet pulp, sunflower seed oil, flaxseed oil, coconut cream, and/or a sugar replacement. In certain embodiments, the frozen desert food product comprises both the anti-freezing and anti-caking system (comprising one or more of the individual ingredients listed in Table 2), as well as one or more other plant-derived systems such as a sugar or sugar replacement, a fat replacement system, a dairy replacement system, an emulsifier and stabilizer system, and a bulking and texturizing system, as listed in Table 3 with their preferred ranges. In some embodiments, the frozen dessert food product is a plant-only ice cream food product.

In example embodiments, the plant-only food product includes a combination of components or ingredients from a plant genus that render the combination (in the amounts as indicated) particularly suitable as an emulsifier and stabilizer system that can be combined with other components or ingredients from a plant genus to form a specific form of food product. Some examples of plant-only food products that incorporate the anti-freezing and anti-caking system as described herein include plant-only frozen dessert products, such as plant-only ice cream, and any other plant-only food products containing plant-derived fats and/or other organic compounds that are insoluble and/or immiscible in aqueous based formulations. In other example embodiments, specific and unique combinations of plant-derived ingredients are combined with the plant-only anti-freezing and anti-caking system to form frozen dessert products such as ice cream having properties very close in similarity with conventional (dairy based) frozen dessert products.

Selection of a specific combination of ingredients for plant-only systems and products (e.g., anti-freezing and anti-caking system and frozen dessert products as described herein) was determined using a proprietary machine learning (ML) platform, which blends ancestral wisdoms of plant nutrition with biotechnology and ML to analyze the plants and compounds nature offers. The platform utilizes algorithms and includes a database with a significant number of ingredients (e.g., 50,000-100,000 ingredients) and relevant physical properties associated with such ingredients. For example, physical characterization data and information about each ingredient for some or all the ingredients in the database include, without limitation, functional properties (e.g., emulsification properties, stabilization properties, bulking properties, texturizing properties, gelling properties, fat-replacement properties, etc.). Ayurvedic and/or other holistic properties, physicochemical properties (e.g. pH, viscosity, moisture content, density, etc.), mechanical properties (e.g. adhesive strength, tensile strength, shear resistance, etc.), chemical and/or molecular descriptor properties (e.g., bio-active/bioavailability properties, molecular structure, phytonutrient properties, etc.), sensorial properties (e.g., taste, smell, color, texture, mouth feel, etc.), and nutritional information (e.g., macronutrient/micronutrient properties, etc.) are also considered in the proprietary system to give optimal results in terms of functionality, health and sustainability. Based upon the known properties of ingredients in the database, the desired properties for the food product or formulation, and one or more algorithms associated with the proprietary machine learning platform, a unique combination of plant-derived components or ingredients was determined to yield an effective formulation that can be used as the anti-freezing and anti-caking system for food based products, such as forming a desirable food product or formulation that is effective as a substitute for conventional dairy based ice cream and other frozen dessert products.

As noted, the proprietary system identifies natural alternatives, i.e., plant-derived alternatives to synthetic, artificial, and animal-derived ingredients, and incorporates, among other things, traditional knowledge known as Ayurvedic medicine. Ayurvedic medicine and its diet principles have been practiced for many thousands of years. This ancient system, among other things, categorizes food by its medicinal properties and desired effects; thus, the proper application of Ayurvedic principles requires knowledge of the self—one's dominant energy, also known as dosha—to prescribe the most advantageous categories of foods from which to choose for an individual's diet. Categories of Ayurvedic properties include but are not limited to Virya (hima/sheeta—cold), Vipaka (Madhura—sweet), Rasa (Madhura—sweet), and Guna (ruksa—dry; or guru—heavy). The information recommended by the proprietary system permits one to choose between hundreds of alternatives based on agents intended to alter a variety of properties to give optimal results for functionality, health, and sustainability.

### Plant-Only Anti-Freezing and Anti-Caking System

Anti-freezing agents are additives that lower the freezing point in a liquid system, aiding in the prevention of ice crystal formation and recrystallization during frozen storage. Anti-freezing agents have lower freezing points and high specific heat conductivity, in general, and remain stable over a wide range of temperatures.

Anti-caking agents are additives that prevent the formation of lumps. They ensure a free-flowing and smooth texture in the food product.

A food product as described herein functions as an anti-freezing and anti-caking system comprising a combination of 100% plant-derived ingredients. The anti-freezing and anti-caking system comprises the following essential categories of ingredients: (i) plant-only fat, such as avocado (e.g., in the form of a pulp or paste); (ii) fruit puree, such as custard apple or banana (e.g., in the form of a pulp or paste); (iii) lignin & cellulose, such as from sugar beet pulp; (iv) vegetable phytosterols & polyunsaturated fatty acids (PUFAs) such as sunflower seed oil; (v) PUFA (including omega-3 fatty acids), such as from flax seed oil; (vi) sources of lauric fatty acid such as coconut cream; and (vii) sugars and/or sugar replacements such as monk fruit powder.

A principal ingredient category in an anti-freezing and anti-caking system for a frozen dessert food product is one or more sources of plant-only fats (i.e., lipids). Avocado is a prime example of a fruit with a high lipid content and is provided as an anti-freezing and anti-caking ingredient in the system due to its high lipid content. Lipids help to stabilize air bubbles in the food product, preventing the formation of ice crystals. Lipids in avocados include oleic acid and other monounsaturated fatty acids (MUFAs), resulting in a creamy texture and mouthfeel. The MUFAs in avocado can function as natural surfactants that, when activated (e.g., when the avocado is mashed or pulverized to form a pulp or fine paste), are highly effective for use in oil and water emulsions. Avocado is further nutrient and phytochemical dense, including fat soluble vitamins such as vitamins A, D, K and E. Avocado contain a high total fat content (about 15% by weight of the avocado), a significant portion of which are MUFAs (about 9.8% by weight), a high phytosterol content (about 57 mg/100 g) and is high in dietary fiber as well as including vitamins A, C, D, K, E and B complex and also minerals such as potassium and magnesium. Avocado pulp contains from 67 to 78% by weight (i.e., by weight of the pulp) moisture, 13.5 to 24% by weight lipids, 0.8 to 4.8% by weight carbohydrates, 1.0 to 3.0% by weight protein, 0.8 to 1.5% by weight ash, and 1.4 to 3.0% by weight fiber, and the avocado pulp further has an energy density between 140 and 228 kcal.

The avocado further has a soft and mushy texture that renders it desirable for a variety of different food products. Avocado fruit used to form the system can be provided as pulp or a paste that is obtained by separating the flesh of the avocado from its skin and seed. The soluble fibers/polysaccharide fractions present in avocado are highly soluble and are potential cryoprotective agents due to their water-binding capacity, gel-forming ability, texturizing, and thickening effects. The water binding capacity of the fiber limits the mobility of water molecules from the bulk aqueous phase to the ice crystal surface phase of the ice cream product.

The amount of avocado provided in the system as well as any food product formed with the system will affect the viscosity of the product, where an increase in amount of avocado in the product will increase the fiber and cause an increase in viscosity of the system and food product, reducing melting rate and overrun. Avocados lower the acidity level of ice cream (pH is 6.1-6.6) and have both soluble and insoluble fibers but the soluble fibers improve the texture of ice cream and effectively control ice crystallization and ice crystal growth during freezing and storage. Avocado promotes the Ayurvedic properties of Rasa (Tikta-bitterness) and Guna (Guru—heavy).

TABLE 4
Functionality and properties of the essential anti-freezing and ant-
caking ingredients for the anti-freezing and anti-caking system intended
for plant-only ice cream and other frozen dessert food products.

| | | | Effect on the | |
|---|---|---|---|---|
| | | | physicochemical | |
| | Anti- | Compound | properties of ice | |
| | caking/anti- | responsible | cream or frozen | |
| Ingredient | freezing | for | dessert food | Ayurveda |
| Category | or both | functionality | product | properties |
| Plant- | Anti-freezing | Avocados | pH - avocado | Rasa: Titka |
| derived fat, | and | contain soluble | paste lower the | (Bitter) |
| such as | anti-caking | fiber, which is | acidity level of the | Guna: Guru |
| avocado | | capable of | ice cream | (Heavy) |
| etc., | | effectively | The acidity level | Snigdha |
| | | controlling ice | of avocado is pH | (oil/smooth) |
| | | crystallization | 6.1-6.6. | Virya: Hima |
| | | and ice crystal | Viscosity - The | (Cold) |
| | | growth during | greater the | Vipaka - Madhura |
| | | freezing and | concentration of | (Sweet) |
| | | storage. | avocado paste | Tikta (Bitter) |
| | | Avocados | results in an | |
| | | contain high | increase in overall | |
| | | lipid | viscosity. | |
| | | content | Melting rate - | |
| | | which helps | higher | |
| | | in | concentration of | |
| | | stabilizing | avocado paste | |
| | | the air | resulted in the | |
| | | bubbles, | increase of | |
| | | prevent the | viscosity of the ice | |
| | | formation | cream mixture | |
| | | of ice | which resulted in a | |
| | | crystals and | decrease in the | |
| | | ensure a | melting rate. | |
| | | smooth and | Overrun - | |
| | | creamy | inversely | |
| | | texture of | proportional to the | |
| | | ice cream. | conc of avocado | |
| | | | paste. | |
| Lignin & | Anticaking | Source of | Viscosity - | Rasa: Madhura |
| cellulose | | cellulose | Increasing the | (Sweet) |
| source, | | and lignin | amount of sugar | Guna: Guru (Heavy) |
| such as | | fraction | beet fiber led to | Snigdha(Smooth) |
| sugar | | obtained | increasing | Virya: Ushna |
| beets | | from dried | consistency | (Heat/hot) |
| | | sugar beet | coefficient and | Vipaka: Madhura |
| | | pulp, which | apparent viscosity | (Sweet) |
| | | contains | values while | |
| | | 22-30% | decreasing flow | |
| | | cellulose. | behavior index of | |
| | | Cellulose | ice cream mixes. | |
| | | has an | Melting rate -Ice | |
| | | affinity for | cream melting | |
| | | moisture | resistance | |
| | | and free fat, | improves by | |
| | | thus can | increasing the | |
| | | prevent | amount of sugar | |
| | | agglomeration | beet fiber. | |
| | | to ensure | Sugar beet fiber up | |
| | | smooth | to 0.7% in ice | |
| | | texture. | cream is | |
| | | The | acceptable. | |
| | | addition of | | |
| | | fiber | | |
| | | (pectin) | | |
| | | improves the | | |
| | | viscosity of | | |
| | | ice cream | | |
| | | and leads to | | |
| | | formation | | |
| | | of smaller | | |
| | | ice crystals | | |
| | | and better | | |
| | | consistency. | | |
| Fruit | Custard | Custard apple | For Custard | For Custard |
| puree | apple is an | contains 3% | Apple: | Apple: |
| such as | anti- | fiber in the | Cryoprotective | Rasa: Madhura (Sweet) |
| from | freezing | pulp which | action: The | Guna: Sheeta/Hima |
| custard | agent | control ice | soluble fibers and | (Cool) |
| apple or | Banana is | crystallization | polysaccharide | Virya: |
| banana | an anti- | during | fractions present | Sheeta/Hima(Cold) |
| | caking | freezing and | are potential anti | Vipaka: Madhura (Sweet) |
| | agent | storage | freezing agents due | For Banana: |
| | | Bananas | to their water | Rasa - Madhura |
| | | contain | binding capacity. | (Sweet), Kashaya |
| | | abundant silica | This limits the | (Astringent) |
| | | that | mobility of water | Guna - Guru(heavy) |
| | | encapsulate | molecules. | Snigdha (oil/smooth) |
| | | powder | Freezing point | Virya - Hima (Cold) |
| | | particles/free | depression: | Vipaka -Amla (Sour) |
| | | flowing | Freezing point is | |
| | | ingredients and | also reduced due | |
| | | absorb ambient | to the | |
| | | liquids, oils | polysaccharides | |
| | | and fats from | and fibers. | |
| | | the surface of | Melting | |
| | | food products | resistance: The | |
| | | to keep them | fibers contribute to | |
| | | from | lowering the | |
| | | agglomerating | melting | |
| | | and giving | temperature | |
| | | smooth | Overrun: The | |
| | | consistency. | fibers present in | |
| | | | the custard apple | |
| | | | decrease the | |
| | | | overrun. The | |
| | | | quantity of custard | |
| | | | apple used is | |
| | | | inversely | |
| | | | proportional to the | |
| | | | overrun. | |
| | | | For Banana: | |
| | | | Melting rate - | |
| | | | Addition of | |
| | | | banana puree led | |
| | | | to the lower value | |
| | | | of complete | |
| | | | melting time of the | |
| | | | ice cream. | |
| | | | Viscosity - | |
| | | | Banana ice cream | |
| | | | showed firmness, | |
| | | | cohesiveness, and | |
| | | | overall acceptance | |
| | | | similar to the | |
| | | | commercial | |
| | | | product | |
| | | | Dripping time: | |
| | | | Banana enriched | |
| | | | ice cream had a | |
| | | | lower dripping | |
| | | | time: | |
| Vegetable | Anti- | Sunflower oil | Decrease in | Rasa: Madhura (sweet) |
| phytosterols | freezing | is high in | overrun and | Guna: Sheeta/Hima |
| such as | and anti- | linoleic acid | melting | (Cool) |
| sunflower | caking | and | resistance. Ice | Virya: Sheeta/Hima |
| seed oil. | | contributes to | cream has lower | (Cold) |
| | | lowering the | viscosity and | Vipaka: Madbura (Sweet) |
| | | freezing point | freezing point | |
| | | of the | | |
| | | product. The | | |
| | | high fat | | |
| | | composition | | |
| | | confers a | | |
| | | smooth and | | |
| | | creamy | | |
| | | texture to the | | |
| | | ice cream. | | |
| | | The seeds are | | |
| | | rich in | | |
| | | polyunsaturated | | |
| | | acids | | |
| | | (linoleic, | | |
| | | oleic) and | | |
| | | tocopherols | | |
| | | (alpha-type | | |
| | | percent of | | |
| | | the total) and | | |
| | | phytosterol | | |
| | | (beta | | |
| | | sitosterol) | | |
| Sugars or | Anti- | Sugar | Effect on | NA |
| Sugar | Freezing | replacements | melting | |
| replacements | | are not only | resistance: Higher | |
| from | | sweeteners | melting rate due | |
| natural | | but also | to low freezing | |
| sources | | affect ice | point | |
| | | cream | Recrystallization: | |
| | | hardness, as | Due to low | |
| | | the sugar | freezing point, | |
| | | content | recrystallization | |
| | | modulates | rates are very low. | |
| | | freezing | The | |
| | | point, which | freezing point is | |
| | | should | largely influenced | |
| | | remain | by the type of | |
| | | between | sugar. The effects | |
| | | minus 10° C. | on the freezing | |
| | | and minus | point depression is | |
| | | 18° C. | related to the | |
| | | Monk fruit | molecular weight. | |
| | | powder is | Disaccharides like | |
| | | one example | sucrose and | |
| | | of a sugar | lactose have a | |
| | | replacement | similar influence | |
| | | that affects | on the freezing | |
| | | the freezing | point depression. | |
| | | point of a | Monosaccharides | |
| | | frozen | like glucose and | |
| | | dessert fruit | fructose have a | |
| | | product. | much larger | |
| | | Other | influence. | |
| | | sources of | A lower | |
| | | sugar include | freezing point will | |
| | | banana and | lead to a lower ice | |
| | | maple syrup. | fraction and to a | |
| | | | decreased hardness | |
| | | | in the food product. | |
| PUFAs, | Anti- | Flaxseed oil is | Melting | Rasa: Madhura |
| incl | Freezing | a source of | point- −18 C. | (Sweet) |
| omega-3 | | omega-3 fatty | Freezing | Tikta (Bitter) |
| fatty acids, | | acids in ice | point- −11 .F | Guna: Guru |
| such as | | cream or frozen | (−24 C.) | (Heavy) |
| flaxseed | | dessert food | Phytochemicals: | Snigdha (Smooth) |
| Oil | | products. As a | omega-3 | Virya: Ushna(Hot) |
| | | partial | and omega-6 fatty | Vipaka: Katu |
| | | substitute for | acids, which are | (Pungent) |
| | | milk fat, | needed for health. | |
| | | flaxseed oil | Flaxseed oil | |
| | | contributes to | contains the | |
| | | minimal fat | essential fatty acid | |
| | | flocculation for | alpha-linolenic | |
| | | a softer ice | acid (ALA), which | |
| | | cream. The | the body converts | |
| | | conversion of | into | |
| | | omega-3 fatty | eicosapentaenoic | |
| | | acids to longer- | acid (EPA), and | |
| | | chain | docosahexaenoic | |
| | | polyunsaturated | acid (DHA), which | |
| | | fatty acids | are longer-chain | |
| | | (PUFAs) | omega-3 fatty | |
| | | promote anti- | acids found in fish | |
| | | freezing | oil | |
| | | properties. | | |
| Source of | Anticaking | Coconut | Lower overrun | Rasa: Madhur |
| lauric acid | | cream | and melting time. | (Sweet) |
| (C12, | | contributes to | Ice cream was | Guna: |
| medium- | | anti-caking | creamy in texture | Hima/Sheeta |
| chain fatty | | properties, but | | (Cold) |
| acid), | | specifically, it | | Snigdha (Oily) |
| such as | | contains high | | Virya: Hima/ |
| coconut | | amounts of fat, | | Sheeta(Cold) |
| cream | | which | | Vipaka: Madhura |
| | | prevents the | | (Sweet) |
| | | interactions | | |
| | | between water | | |
| | | and other | | |
| | | ingredients. | | |
| | | Coconut | | |
| | | cream is thick | | |
| | | and aids in | | |
| | | providing a | | |
| | | smooth texture | | |
| | | to the ice | | |
| | | cream. | | |
| | | Coconut | | |
| | | cream is the | | |
| | | richest natural | | |
| | | source of | | |
| | | lauric acid. | | |
| | | Lauric acid | | |
| | | and its | | |
| | | derivative, | | |
| | | monolaurin, | | |
| | | constitute | | |
| | | roughly 50% | | |
| | | of coconut fat- | | |
| | | derived lipids. | | |

Unique combination of essential ingredients for a plant-only ice cream or other frozen dessert products was determined to provide anti-freezing and anti-caking functionalities, as noted in Table 4. In the disclosed embodiments the percent ratio of a plant-only fat source such as the avocado ranges from about 1 to about 25 percent of the anti-freezing and anti-caking system, between about 1 to about 10 percent, between about 2 to about 12 percent, between about 2 to about 12 percent, between about 2 to about 14 percent, between about 2 and about 8 percent, between about 2 to about 4 percent, between about 2 to about 6 percent, between about 3 to about 9 percent, between about 3 and about 5 percent, between about 3 to about 9 percent, between about 4 and about 11 percent, between about 5 and about 8 percent, between about 5 to about 10 percent, between about 5 and about 13 percent, between about 5 and about 15 percent, between about 6 and about 12 percent, between about 7 and about 13 percent, between about 7 and about 17 percent, between about 8 and about 17 percent, between about 10 and about 18 percent, between about 11 and about 15 percent, between about 12 and about 16 percent, and between about 15 and about 20 percent.

Fruit puree is another important ingredient category of the disclosed anti-freezing and anti-caking system. Representative examples of fruit puree that may be included in any anti-freezing and anti-caking system include custard apple and banana. Custard apple grows on trees in tropical and sub-tropical regions; the fruit has sweet, juicy, creamy white colored flesh and contains high amounts of sugar, thus contributing to the sweetness in the ice cream or other frozen dessert food product. With respect to anti-freezing properties, custard apple contains 3% fiber in the pulp, which controls ice crystallization during freezing and storage. Soluble fibers and polysaccharide fractions present are potential anti-freezing agents due to their water binding capacity, which limits the mobility of water molecules, lowers the freezing point and melting temperature of the final food product in which it is a component. Overrun is also reduced when custard apple is included in formulations of plant-only ice creams. Custard apple fruit can be peeled, and the pulp is then mashed to form a uniform puree or paste when combined with the other ingredients forming the food product. Custard apple promotes the Ayurvedic properties of Rasa: (Madhura—sweet), Guna: (Sheeta/Hima—cool); Virya: (Sheeta/Hima—cold); and Vipaka: (Madhura—sweet), as shown in Table 4.

Banana, with its firmness and cohesiveness (due, at least in part, to its pectin content), fibrous texture, and good resistance to temperature fluctuations, enhances the properties of an anti-freezing and anti-caking system as an anti-caking agent. Bananas contain abundant silica that encapsulates powder particles and free flowing ingredients, and absorb ambient liquids, oils and fats from the surface of food products, and results in a smooth consistency to food products in which it is used. In addition, starches in banana are relatively low in amylase content, have high resistance to heating and amylase attack, low swelling properties, and low retrogradation, which renders banana in the food industry useful as a gelling agent, thickening agent and stabilizer. The banana (e.g., Cavendish banana) is peeled to have its skin removed and can also be provided in a pulp, puree or paste form. The pH of bananas ranges between 4 and 6, contributing to its ability to neutralize a more acidic mixture. Bananas also affect overrun in that polysaccharides in banana contribute to foam stability, leading to air adsorption in ice cream. The amount of banana in a mixture also affects melting resistance, resulting in a lower dripping rate: the greater the amount of banana, the more slowly the ice cream or other frozen dessert will melt. This is in part due to the soluble pectin fibers present in banana, which increase the viscosity of ice cream (providing a creamy texture). Sugars present in banana also provide sweetness and bulk to the food product, as indicated in Table 4. Banana promotes the Ayurvedic properties of Rasa (Madura—sweet), Kashaya (astringent), Guna (Guru—heavy), Snigdha (oily/smooth), Virya (Hima—cold) and Vipaka (Madhura—sweet).

In the disclosed embodiments the percent ratio of fruit puree such as custard apple or banana in the anti-freezing and anti-caking system ranges from about 1 to about 25 percent of the food product, between about 1 to about 10 percent, between about 2 to about 4 percent, between about 2 to about 6 percent, between about 2 to about 8 percent, between about 2 and about 10 percent, between about 2 to about 12 percent, between about 2 to about 14 percent, between about 3 to about 5 percent, between about 3 and about 7 percent, between about 3 to about 9 percent, between about 4 and about 8 percent, between about 5 and about 8 percent, between about 5 to about 10 percent, between about 5 and about 13 percent, between about 5 and about 15 percent, between about 6 and about 8 percent, between about 7 and about 11 percent, between about 7 and about 14 percent, between about 8 and about 15 percent, between about 10 and about 15 percent, and between about 12 and about 15 percent.

One or more sources of lignin and cellulose fibers are included in the third category of the preferred anti-freezing and anti-caking system. A prime example of a plant source rich in these fibers is the sugar beet pulp. Due to its pectin (fiber) content, sugar beet pulp functions as an anti-caking agent within the anti-freezing and anti-caking system of the ice cream or other frozen food product. Lignocellulose fractions hold moisture and free fats, preventing agglomeration and ensuring a smooth and creamy texture to the food product. Sugar beet pulp content up to 0.7 percent of the final food product is acceptable in most cases. In certain formulations it can be higher, up to roughly 3.5 percent. However, levels rising significantly above 0.7 percent of the food product may cause deterioration of certain properties. The pulp further increases viscosity and leads to formation of smaller ice crystals and better consistency, decreasing the flow behavior index and resulting in a slowed melting rate. Sugar beet pulp promotes the Ayurvedic properties of Rasa (Madura—sweet), Guna (Guru—heavy), Snigdha (smooth), Virya (Ushna—heat/hot) and Vipaka (Madhura—sweet), as indicated in Table 4.

In the anti-freezing and anti-caking system (the formulation of essential components to the system), highly soluble fiber and polysaccharide fractions present in avocado, sugar beets and custard apple, as well as plant-derived proteins, act as potential cryoprotective agents due to their water-binding capacity, gel-forming capacity, texturizing capacity, and thickening effects. The water binding capacities of these essential ingredients limit the mobility of water molecules from the bulk aqueous phase to the ice crystal surface phase. The addition of fat rich ingredients (avocado, coconut cream and sunflower oil in particular) in combination with sugar beet pulp (a source of pectin) act as anti-caking agents, reducing the formation of large ice crystals and improving the mouth coating property of the ice cream or other frozen dessert food products. Blends of solid and liquid fats (at room temperature), e.g., sunflower seed oil and avocado, are preferred to achieve optimal partial coalescence. The resulting ice cream food product, containing the essential agents of the anti-freezing and anti-caking system, demonstrates good partial coalescence (a property that determines the structural and textural attributes of ice cream and other frozen desserts), creaminess, and extended meltdown.

In the disclosed embodiments the percent ratio of one or more sources of lignin and cellulose fibers, such as sugar beet pulp, ranges from about 1 to about 25 percent of the anti-freezing and anti-caking system, between about 1 to about 10 percent, between about 2 to about 12 percent, between about 2 to about 12 percent, between about 2 to about 14 percent, between about 2 and about 8 percent, between about 2 to about 4 percent, between about 2 to about 6 percent, between about 3 to about 9 percent, between about 3 and about 5 percent, between about 3 to about 9 percent, between about 4 and about 11 percent, between about 5 and about 8 percent, between about 5 to about 10 percent, between about 5 and about 13 percent, between about 5 and about 15 percent, between about 6 and about 12 percent, between about 7 and about 13 percent, between about 7 and about 17 percent, between about 8 and about 17 percent, between about 10 and about 18 percent, between about 11 and about 15 percent, between about 12 and about 16 percent, and between about 15 and about 20 percent.

Another preferred anti-freezing and anti-caking system ingredient categories is a source of vegetable phytosterols & PUFAs, such as sunflower seed oil. Sunflower oil is both an anti-freezing and anti-caking agent. It is pressed from the seeds of the sunflower and is considered a healthy fat because it contains little (˜15%) saturated fat. It is primarily composed of linoleic acid (44-75%), a polyunsaturated fatty acid, and oleic acid (˜14-43%), a monounsaturated fatty acid. The greater polyunsaturated acid content of sunflower oil contributes to its lower freezing point in food products. The addition of sunflower seed oil (a fat) to the anti-freezing and anti-caking system as part of a food product confers a smooth and creamy texture, and decreases overrun, viscosity and melting resistance. Sunflower seed oil promotes the Ayurvedic properties of Rasa (Madura—sweet), Guna (Sheeta/Hima—cool), Virya (Sheeta/Hima—cold) and Vipaka (Madhura—sweet), as indicated in Table 4.

In the disclosed embodiments the percent ratio of a source of vegetable phytosterols and PUFAs such as sunflower seed oil, ranges from about 1 to about 25 percent of the anti-freezing and anti-caking system, between about 1 to about 10 percent, between about 2 to about 12 percent, between about 2 to about 12 percent, between about 2 to about 14 percent, between about 2 and about 8 percent, between about 2 to about 4 percent, between about 2 to about 6 percent, between about 3 and about 5 percent, between about 3 to about 9 percent, between about 3 to about 15 percent, between about 4 and about 11 percent, between about 5 and about 8 percent, between about 5 to about 10 percent, between about 5 and about 13 percent, between about 5 and about 15 percent, between about 6 and about 12 percent, between about 7 and about 13 percent, between about 7 and about 17 percent, between about 8 and about 17 percent, between about 10 and about 18 percent, between about 11 and about 15 percent, between about 12 and about 16 percent, and between about 15 and about 20 percent.

A fifth category of ingredients within the anti-freezing and anti-caking system is one or more sources of PUFAs that specifically include omega-3 fatty acids, such as flaxseed oil. Flaxseed oil is the edible form of oil pressed from the dried seed of flax plants and is prized as an important source of omega-3 polyunsaturated fatty acids. In particular, α-linolenic acid is converted by the body into longer chain polyunsaturated fatty acids, eicosapentaenoic acid (EPA) and docosahexaenoic acid (DHA), the same acids found in fish oil. Flax seed oil contains both omega 3 and omega-6 polyunsaturated fatty acids (α-linolenic acid (˜ 52-55%); linoleic acid (˜14-17%); and a monounsaturated fatty acid, oleic acid (˜ 18-23%), in addition to a small amount of saturated fatty acids (palmitic (˜7%); and stearic (˜3-5%)). Due to its higher polyunsaturated fatty acid content, it resists freezing in standard temperature freezers (freezing point is −11° F. (−24° C.), melting point is −0.4° F. (−18° C.)). Flax seed oil promotes the Ayurvedic properties of Rasa (Madura—sweet), Tikta (bitter), Guna (Guru—heavy), Snigdha (smooth), Virya (Ushna—hot) and Vipaka (Katu—pungent), as indicated in Table 4.

In the disclosed embodiments, the percent ratio of PUFA, including omega-3 fatty acids, such as flax seed oil, ranges from about 1 to about 25 percent of the anti-freezing and anti-caking system, between about 1 to about 10 percent, between about 2 to about 12 percent, between about 2 to about 12 percent, between about 2 to about 14 percent, between about 2 and about 8 percent, between about 2 to about 4 percent, between about 2 to about 6 percent, between about 3 and about 5 percent, between about 3 to about 9 percent, between about 3 to about 15 percent, between about 4 and about 11 percent, between about 5 and about 8 percent, between about 5 to about 10 percent, between about 5 and about 13 percent, between about 5 and about 15 percent, between about 6 and about 12 percent, between about 7 and about 13 percent, between about 7 and about 17 percent, between about 8 and about 17 percent, between about 10 and about 18 percent, between about 11 and about 15 percent, between about 12 and about 16 percent, and between about 15 and about 20 percent.

A sixth category of ingredients in the anti-freezing and anti-caking system includes one or more sources of fats, particularly containing lauric acid (C12), such as coconut cream. Coconut cream is a high fat, anti-caking agent and is the product of cooking the flesh of the coconut, resulting in a thick, creamy product that is rich in healthy fats, such as medium-chain triglycerides (MCTs). It has a mild taste and improves the creaminess and smoothness, as well as a thick consistency of ice cream, for example. The addition of coconut cream reduces the overrun values of ice cream, decreases its melting rate, and increases its viscosity. Coconut cream provides fatty acids that mimic dairy-based fats in plant-only food products such as ice cream or other frozen food products. It reduces overrun and melting rate and increases viscosity of food product of which it is a component. Coconut cream also promotes the Ayurvedic properties of Rasa (Madura—sweet), Guna Hima/Sheeta—cold), Snigdha (oily), Virya (Hima/Sheeta—cold) and Vipaka (Madhura—sweet), as indicated in Table 4.

In the disclosed embodiments, the percent ratio of sources of fats containing lauric acid (a C12, medium-chain fatty acid), such as coconut cream, ranges from about 1 to about 20 percent of the anti-freezing and anti-caking system, between about 1 to about 10 percent, between about 2 to about 12 percent, between about 2 to about 12 percent, between about 2 to about 14 percent, between about 2 and about 8 percent, between about 2 to about 4 percent, between about 2 to about 6 percent, between about 3 and about 5 percent, between about 3 to about 9 percent, between about 3 to about 15 percent, between about 4 and about 11 percent, between about 5 and about 8 percent, between about 5 to about 10 percent, between about 5 and about 13 percent, between about 5 and about 15 percent, between about 6 and about 12 percent, between about 7 and about 13 percent, between about 7 and about 17 percent, between about 8 and about 17 percent, between about 10 and about 18 percent, between about 11 and about 15 percent, between about 12 and about 16 percent, and between about 15 and about 20 percent.

A seventh preferred category of ingredients in the anti-freezing and anti-caking system comprises sugars and/or sugar replacements. Plant-derived sugars and sugar replacements from natural sources such as maple syrup, monk fruit powder, and banana may be used, depending on the desired degree of sweetness, texture, bulking, anti-freezing, and anti-caking properties of the final food product. A sugar replacement as a low calorie, sweetening agent can be obtained in small amounts as it can be found naturally in plant foods such as monk fruit. Sugars in these plants and fruits positively impact the texture and mouthfeel of the ice cream product. Physicochemical properties of sugar replacements can include reduction in energy provided, (i.e., a reduced caloric content from sucrose at 4 kcal/g to 0.4 kcal/gram), reduced freezing point, improved melting resistance (due to lower freezing point), low recrystallization rate, and dual (liquid and crystalline) forms, as indicated in Table 4.

In the disclosed embodiments the percent ratio of the sugars and/or sugar replacements (in combination) range from about 1 to about 25 percent of the anti-freezing and anti-caking system, between about 1 to about 10 percent, between about 2 to about 12 percent, between about 2 to about 12 percent, between about 2 to about 14 percent, between about 2 and about 8 percent, between about 2 to about 4 percent, between about 2 to about 6 percent, between about 3 to about 9 percent, between about 3 and about 5 percent, between about 3 to about 9 percent, between about 4 and about 11 percent, between about 5 and about 8 percent, between about 5 to about 10 percent, between about 5 and about 13 percent, between about 5 and about 15 percent, between about 6 and about 12 percent, between about 7 and about 13 percent, between about 7 and about 17 percent, between about 8 and about 17 percent, between about 10 and about 18 percent, between about 11 and about 15 percent, between about 12 and about 16 percent, and between about 15 and about 20 percent.

Alone or in combination, the previously described ingredient categories (plant-only fats and fibers, sources of sugars or sugar replacements, sources of PUFAs and MCTs, etc.) are effective in anti-freezing and anti-caking system for frozen food products, such as ice cream.

### Plant-Only Ice Cream and Other Frozen Dessert Food Products

When using the anti-freezing and anti-caking system or any of the individual plant-derived ingredients that comprise the system, the ingredients, alone or in combination, can be combined with one or more additional plant-derived systems to enhance properties of the plant-only frozen dessert product such as energy content, pH, viscosity, flavor profile, melting resistance, freezing/recrystallization points, etc. For example, plant-derived fat replacement systems, dairy replacement systems, bulking and texturizing system, additional sugars or sugar replacements may be combined with the anti-freezing and anti-caking system in varying amounts to create thousands of combinations of 100% plant-only systems to create 100% plant-only, or nearly 100% plant-only, ice creams and other frozen dessert food products.

Additional plant-derived ingredients that have been found essential, when combined with the system described herein, in forming unique plant-only ice cream or other frozen dessert food products are as follows: plant-derived cream (e.g., coconut cream, cashew cream, etc.), plant-derived starch (e.g., tapioca starch, potato starch, rice starch, etc.), one or more additional plant-derived proteins (e.g., lupin protein), one or more additional types of plant-derived fiber (e.g., lupin fiber), one or more additional plant-derived oils or fatty acids (e.g., sunflower oil, olive oil, etc.), one or more additional plant-derived sugars and/or sugar replacements (e.g., allulose, custard apple fruit, etc.), and a plant-derived fat replacement system, and a dairy replacement system, a plant-only emulsifying and stabilizing system, and a plant-only bulking and texturizing system (e.g., tapioca starch, legumes). The essential ingredient formulation can comprise the system and any one or more (e.g., any two or more, any three or more, etc.) of these further additional plant-derived ingredients as described herein. In an example, a particularly useful formulation was determined as including the system and all of the additional essential ingredients as described herein.

For example, additional proteins and fiber solely derived from a plant genus, such as from legumes (e.g., pea or lupin proteins, and pea or lupin fiber derived from lupin beans from the Lupinus sub-genus within a plant genus) enhance the properties of the plant-only anti-freezing and anti-caking system (and plant-derived individual ingredients) with regard to plant-only frozen dessert products. Custard apple fruit can be provided in the system to increase the sugars/sweetness and creamy/gelling/stability (due to the pectin content) of the formulation and final frozen dessert food product.

The fiber content and polysaccharide fractions in the avocado, banana, plant-derived fiber and proteins (such as from sugar beet, and chickpeas/peas or other legumes), can be cryoprotective agents due to their water-binding capacity, gel-forming ability, texturizing, and thickening effects, thus providing anti-freezing properties for the ice cream product. The water binding capacity of the fiber limits the mobility of water molecules from the bulk aqueous phase to the ice crystal surface phase. The addition of fat rich ingredients (e.g., avocado and coconut cream) and fiber/pectin source (sugar beet) provide anti-caking properties as they are responsible for the creamy and smooth texture of ice cream. They reduce the formation of large ice crystals and improve the mouth coating property.

Water is also combined with the ingredients to render the system as an aqueous based formulation. While some water may be extracted from a plant source and provide another source of important nutrients, water is also sourced from purified water bottlers.

### Example of Forming a Plant-Only Ice Cream Product Including Anti-Freezing and Anti-Caking System and Other Essential Components

The essential anti-freezing and anti-caking categories of ingredients (as noted in Table 2 herein) include the specific examples of ingredients that form the anti-freezing and anti-caking system in one embodiment. The formulation is made in some embodiments by combining and mixing the ingredients in any suitable manner, any suitable order, and any suitable combination(s). In the formation process, the avocado fruit and banana fruit may first be soaked (separately or together) in lemon juice and/or lime juice to minimize, prevent and/or delay enzymatic browning of these ingredients and prior to their combination with other plant-derived bulking and texturizing ingredients forming the anti-freezing and anti-caking system, and possibly additional ingredients forming the food product.

In one formulation embodiment, an anti-freezing and anti-caking system for use in a frozen dessert (e.g., ice cream) food product with the ingredients and systems as set forth in Tables 2 and 3 is described as follows. All the plant-derived ingredients are obtained from fresh plant sources or minimally processed sources. If fresh plant sources are used for the system ingredients, the avocado and banana are peeled, and the avocado is de-seeded. Both fruits are mashed into a pulp, paste or puree form and are uniformly mixed and combined in amounts to be at the same or similar weight percentage ratio with each other (e.g., about a 50:50 weight ratio). The combined pulp mixture is immersed in lemon juice and/or lime juice for a suitable period (e.g., about 15 minutes). The pulp is then separated from the lemon and/or lime juice prior to combination with the other ingredients listed in Table 2. Water may be added as necessary.

Plant-only protein and plant-only fiber ingredients (e.g., sugar beet pulp, legumes such as pea, or lupin protein and lupin fiber) are combined along with plant-derived (e.g., tapioca) starch, plant-derived (e.g., coconut) cream, and other plant-derived sugars at ambient/room temperature (about 23° C. to about 30° C.) and mixed together in a suitable blender or turbo mixer for a suitable time period and at a suitable mixing speed in the range of 18000-28000 RPM, to obtain a uniform mixture of ingredients. This mixture is then pasteurized by continuous mixing for a suitable period of about 15-30 minutes and at a temperature of about 68-75° C.

Any further plant-derived ingredients are then added to the uniform mixture, with further mixing and homogenization of the ingredients via blender or turbo mixer. Upon sufficient homogenization of the mixture, the contents are further mixed in an ice cream machine that churned the mixture while it was being cooled until a temperature of about −8° C. is reached. Churning also facilitates aeration of the ice cream product to generate a desired amount of ice crystallization and overrun in the final product. After this mixing, the product was further processed within a blast chiller that blows chilled air to rapidly cool the temperature of the product to about −22° C., thus forming the plant-only ice cream product.

The combination of each plant-only anti-freezing and anti-caking system ingredients with the other ingredients or systems (fat replacement, milk and egg replacement, bulking and texturizing, emulsifiers and stabilizers, etc.), when combined in the manner described herein, facilitate the formation of a plant-only (i.e., 100% or nearly 100% plant-only) final ice cream food product or any other frozen dessert product that resembles conventional ice cream or other conventional frozen dessert products (i.e., dairy based ice cream and frozen dessert products) with regard to look, mouth feel, texture, appearance, melting conditions, consistency and, most importantly, taste.

A wide range of plant-only ice cream products or other plant-only frozen dessert products can be formed with the essential plant-derived ingredients and systems as described herein.

In the disclosed embodiments, the weight percent of the system in the final food product produced will vary according to specific food product. Where water has been added to the formulation for any particular frozen dessert food product, its content in the food product ranges between about 55 to about 65 percent of the final weight of the food product, between about 45 to about 50 percent, between about 47 to about 53 percent, between about 50 to about 55 percent, between about 52 to about 58 percent, between about 55 and about 60 percent, between about 57 to about 63 percent, between about 60 to about 65 percent, between about 62 to about 68 percent, between about 65 and about 70 percent, between about 67 to about 72 percent, between about 70 and about 75 percent, between about 45 and about 55 percent, between about 45 to about 65 percent, between about 55 and about 65 percent, between about 55 and about 75 percent, and between about 65 and about 75 percent.

In embodiments where a bulking and texturizing system has been added to the formulation for any particular frozen dessert food product, its content in the food product ranges between about 8 to about 10 percent of the final weight of the food product, between about 5 to about 10 percent, between about 8 to about 13 percent, between about 10 to about 15 percent, between about 6 to about 8 percent, and between about 8 and about 10 percent.

In embodiments where a sugar and/or sugar replacement or system has been added to the formulation for any particular frozen dessert food product, its content in the food product ranges between about 10 to about 15 percent of the final weight of the food product, between about 5 to about 10 percent, between about 8 to about 15 percent, between about 10 to about 15 percent, between about 15 and about 20 percent, about 5 to about 8 percent, between about 8 and about 13 percent and between about 12 and about 18 percent.

In embodiments where a fat replacement system has been added to the formulation for any particular frozen dessert food product, its content in the food product ranges between about 2 to about 10 percent of the final weight of the food product, between about 0.1 to about 2 percent, between about 0.2 to about 4 percent, between about 0.3 to about 5 percent, between about 0.5 and about 3 percent, between about 0.5 and about 5 percent, between about 1 and about 5 percent, about 1 to about 8 percent, between about 2 and about 5 percent, between about 2 and about 8 percent, between about 3 and about 5 percent, between about 3 and about 6 percent, between about 3 and about 9 percent, between about 4 and about 6 percent, between about 4 about 8 percent, between about 6 and about 8 percent, and between about 8 and about 10 percent.

In embodiments where a dairy replacement system has been added to the formulation for any particular frozen dessert food product, its content in the food product ranges between about 5 to about 15 percent of the final weight of the food product, between about 1 to about 5 percent, between about 1 to about 8 percent, between about 1 to about 12 percent, between about 2 to about 10 percent, between about 3 to about 13 percent, between about 5 to about 8 percent, between about 5 to about 10 percent, between about 5 to about 15 percent, between about 10 and about 13 percent, between about 8 to about 15 percent, between about 10 to about 15 percent, between about 15 and about 20 percent, and between about 12 and about 18 percent.

In embodiments where an emulsifier and stabilizer system has been added to the formulation for any particular frozen dessert food product, its content in the food product ranges between about 0.5 to about 5 percent of the final weight of the food product, between about 0.1 to about 2 percent, between about 0.2 to about 4 percent, between about 0.3 to about 5 percent, between about 0.5 and about 3 percent, between about 0.5 and about 5 percent, between about 1 and about 5 percent, about 1 to about 8 percent, between about 2 and about 5 percent, between about 2 and about 8 percent, between about 3 and about 5 percent, between about 3 and about 6 percent, between about 3 and about 9 percent, between about 4 and about 6 percent, between about 4 about 8 percent, between about 6 and about 8 percent, and between about 8 and about 10 percent.

In embodiments where an anti-freezing and anti-caking system has been added to the formulation for any particular frozen dessert food product, its content in the food product ranges between about 0.5 to about 5 percent of the final weight of the food product, between about 0.1 to about 2 percent, between about 0.2 to about 4 percent, between about 0.3 to about 5 percent, between about 0.5 and about 3 percent, between about 0.5 and about 5 percent, between about 1 and about 5 percent, about 1 to about 8 percent, between about 2 and about 5 percent, between about 2 and about 8 percent, between about 3 and about 5 percent, between about 3 and about 6 percent, between about 3 and about 9 percent, between about 4 and about 6 percent, between about 4 about 8 percent, between about 6 and about 8 percent, and between about 8 and about 10 percent.

The combination of avocado and banana (rich in lipids, sugars, saponins and phenolic acids) and coconut cream provide a creamy texture with desirable rheological parameters of consistency and viscosity for the ice cream products, as well as a favorable freezing point for the ice cream products without the requirement for any animal fats, stabilizers, emulsifiers, and anti-freezing additives apart from those that are already provided and 100% plant-derived or are based in part on plant-derived ingredients.

The high-fat content of avocado within the system with its rich presence of oleic acid (fatty acid) and phospholipid compounds (natural surfactants providing the emulsification properties) helped to mimic/provide similar functionalities as milk fat that are provided in conventional dairy based ice creams, where the avocado aided in maintaining the whipping ability and homogeneity of the ice cream. Banana pulp, with its firmness and cohesiveness (resulting from the pectin polymer's content), fibrous texture, and good resistance to temperature fluctuations helped create a mix that contained the freezing and melting properties ideal for ice cream. The banana sugars also enhanced the sweet taste of the ice cream product.

Thus, the unique combination of essential ingredients as described herein and listed in Table 3, which are 100% plant-derived ingredients to replace the highly processed, artificial/synthetic additives and conventional animal ingredients in foods, particularly ice cream and other frozen dessert products, meet the functionalities of animal and dairy based additives in food products while also providing nutritional benefits for the food products.

### Method of Preparation of the Plant-Only Anti-Freezing and Anti-Caking System

At step 102, a) 5.0-25% by weight of a fat source, b) 5-20% by weight of a fruit puree source, c) 5.0-25% by weight of a lignin & cellulose source, d) 5.0-25% by weight of a vegetable phytosterols & PUFA source, e) 5-25% by weight of a PUFA & Omega-3-Fatty acid source, f) 3-20% by weight of a Lauric acid source, and g) 5-25% by weight of a sugars and/or sugar replacement source is mixed in a blender at an RPM of 18000 to 28000 RPM, to obtain a first homogeneous mixture. At step 104, the first homogeneous mixture is pasteurized by continuous mixing for about 15 to 30 minutes at a temperature of 68 to 75 degrees Celsius to obtain the plant-only anti-freezing and anti-caking system for food products.

In embodiments, Avocado fruit used as the fat source is provided as a mashed pulp, paste or puree by first separating the flesh of the avocado from its skin and seed and then mixed (e.g., in a blender or turbo mixer) for a suitable time to form a past or puree of a desired texture and consistency.

In embodiments, Banana and custard apple used as the fruit puree source is peeled and the pulp is then mashed to form a uniform puree or paste. Banana puree is obtained by separating the flesh of banana from peels followed by mashing.

In embodiments, Sugar beet (fiber pectin) used as the Lignin and Cellulose source is extracted by enzymatic hydrolysis. In citrate buffer at 25° C., xylanase and cellulase are combined in a 1:1.5 ratio. At 50° C. with shaking at 150 rpm for 4 hours, ground sugar beet pulp (SBP) is added to the enzyme mixture at a ratio of 1:15. The enzymes are then inactivated by being heated for 5 minutes at 100° C. Vacuum filtration is used to separate the remaining de-pectinated SBP from the soluble components before being rinsed with distilled water. The filtrate is then centrifuged at 10,000 rpm for 10 minutes and the pectin is precipitated. The precipitated pectin is washed, centrifuged, and dried at 40° C. for 48 hours after being centrifuged at 10,000 rpm for two hours.

In embodiments, Sunflower oil used as the vegetable Phytosterols PUFA source is prepared by cleaning and dehulling seeds. The seeds are ground into a coarse meal followed by size reduction in finer particles by rollers. This fine meal is heated to enable oil extraction. The heated meal is pressed in a screw press with pressure of 60 kps and more. The squeezed oil is collected and finally deodorized in a vacuum at 225 C.

In embodiments, Flaxseed oil used as PUFA and Omega-3-Fatty acid source is prepared by cleaning Flaxseeds and drying for four hours at 105° C. in an oven, and then ground into a powder using a mortar and pestle. A round-bottomed flask, a water condenser, and the extraction thimble are all added to the soxhlet extraction apparatus together with the ground material. Petroleum ether (60-80° C.) is used to extract oil seeds for 8 hours. Following extraction, petroleum ether is withdrawn under reduced pressure. The oil is then kept in storage.

In embodiments, Coconut cream used as Lauric acid source is prepared by shredding the coconut in a motorized rotary grater to separate the white meat from the shell and blending at high speed with an equivalent volume of water (w/w). The cream is subsequently obtained by pressing the slurry through two layers of cheesecloth.

Optionally, the coconut cream is prepared by mixing the shredded coconut with water. The mixture is homogenized and filtered to remove the water layer and the creamy layer is retained.

In embodiments, Monk fruit powder used as the sugars and/or sugar replacement source is prepared by peeling the fruit peel and removing the seeds. The juice is collected by crushing the fruit. The juice is then dried to obtain the concentrated powder.

Merely for illustration, only representative number/type of graph, chart, block, and sub-block diagrams were shown. Many environments often contain many more block and sub-block diagrams or systems and sub-systems, both in number and type, depending on the purpose for which the environment is designed.

While specific embodiments of the disclosed embodiments have been shown and described in detail to illustrate the inventive principles, it will be understood that the disclosed embodiments may be embodied otherwise without departing from such principles.

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment” and similar language throughout this specification may, but do not necessarily, all refer to the same embodiment.

It should be understood that the figures and/or screen shots illustrated in the attachments highlighting the functionality and advantages of the disclosed embodiments are presented for example purposes only. The disclosed embodiments are sufficiently flexible and configurable, such that it may be utilized in ways other than that shown in the accompanying FIGURES.

It should be understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

1. A plant-only anti-freezing and anti-caking system for food products comprising:
a) 5.0-25% by weight of a fat source, b) 5-20% by weight of a fruit puree source, c) 5.0-25% by weight of a lignin & cellulose source, d) 5.0-25% by weight of a vegetable phytosterols & PUFA source, e) 5-25% by weight of a PUFA & Omega-3-Fatty acid source, f) 3-20% by weight of a Lauric acid source, and g) 5-25% by weight of a sugars and/or sugar replacement source.

2. The anti-freezing and anti-caking system of claim 1, wherein the fat source is selected from Avocado, sunflower oil, olive oil, mango kernel fat, Peanut, oil, palm kernel oil, soybean oil, safflower oil, cocoa butter, corn oil, flaxseed oil, sesame oil or combinations thereof.

3. The anti-freezing and anti-caking system of claim 1, wherein the fruit puree source is selected from custard apple puree, banana puree, apple puree, avocado puree, pear puree, muskmelon puree, papaya puree, prunes puree, apricot, mango puree, dragon fruit puree or combinations thereof.

4. The anti-freezing and anti-caking system of claim 1, wherein the lignin & cellulose source is selected from Sugar beet, Peaches, oat bran, artichoke, chicory root, quinoa, peas, navy beans, white beans and adzuki beans or combinations thereof.

5. The anti-freezing and anti-caking system of claim 1, wherein the vegetable phytosterols & PUFA source is selected from Sunflower oil, soybean oil, peas, sesame oil, kidney beans, almonds, olive oil, pistachios, pecans, walnuts, corn oil or combinations thereof.

6. The anti-freezing and anti-caking system of claim 1, wherein the PUFA & Omega-3-Fatty acid source is selected from Flaxseed Oil, chia seeds, hemp seeds, walnuts, kidney beans, wheat germ, butter nut, red currant seeds, black currant seeds, pumpkin seeds, purslane or combinations thereof.

7. The anti-freezing and anti-caking system of claim 1, wherein the lauric acid source is selected from Coconut cream, bay laurel berry kernel, palm kernel oil, babassu Oil, cohune oil, macadamia nuts, cashews, peanuts, star anise seed oil, Mucajá nut or combinations thereof.

8. The anti-freezing and anti-caking system of claim 1, wherein the sugars and/or sugar replacement source is selected from monk fruit powder, Banana, maple syrup, Custard apple, Raisins, Durian, Pears, Prunes, Sapodilla, Agave, Dried apricots, Date palm, Mangosteen, Barhi dates or combinations thereof.

9. The anti-freezing and anti-caking system of claim 1, wherein the food product is a frozen dessert product, shredded cheese, milk and cream powder, flour-based mix, cocoa and mixed coffee beverage, frozen dough, and frozen noodles.

10. A method of preparing a plant-only anti-freezing and anti-caking system for food products, wherein the method comprises:
a) 5.0-25% by weight of a fat source, b) 5-20% by weight of a fruit puree source, c) 5.0-25% by weight of a lignin & cellulose source, d) 5.0-25% by weight of a vegetable phytosterols & PUFA source, e) 5-25% by weight of a PUFA & Omega-3-Fatty acid source, f) 3-20% by weight of a Lauric acid source, and g) 5-25% by weight of a sugars and/or sugar replacement source in a blender at an RPM of 18000 to 28000 RPM, to obtain a first homogeneous mixture;
pasteurizing the first homogeneous mixture by continuous mixing for about 15 to 30 minutes at a temperature of 68 to 75 degrees Celsius to obtain the plant-only anti-freezing and anti-caking system for food products.

11. The method of claim 10, wherein the method comprises mixing the plant-only anti-freezing and anti-caking system with the food products to produce the anti-freezing and anti-caking effect to the food products.

12. The method of claim 10, wherein the fat source is selected from Avocado, sunflower oil, olive oil, mango kernel fat, Peanut, oil, palm kernel oil, soybean oil, safflower oil, cocoa butter, corn oil, flaxseed oil, sesame oil or combinations thereof.

13. The method of claim 10, wherein the fruit puree source is selected from custard apple puree, banana puree, apple puree, avocado puree, pear puree, muskmelon puree, papaya puree, prunes puree, apricot, mango puree, dragon fruit puree or combinations thereof.

14. The method of claim 10, wherein the lignin & cellulose source is selected from Sugar beet, Peaches, oat bran, artichoke, chicory root, quinoa, peas, navy beans, white beans and adzuki beans or combinations thereof.

15. The method of claim 10, wherein the vegetable phytosterols & PUFA source is selected from Sunflower oil, soybean oil, peas, sesame oil, kidney beans, almonds, olive oil, pistachios, pecans, walnuts, corn oil or combinations thereof.

16. The method of claim 10, wherein the PUFA & Omega-3-Fatty acid source is selected from Flaxseed Oil, chia seeds, hemp seeds, walnuts, kidney beans, wheat germ, butternut, red currant seeds, black currant seeds, pumpkin seeds, purslane or combinations thereof.

17. The method of claim 10, wherein the lauric acid source is selected from Coconut cream, bay laurel berry kernel, palm kernel oil, babassu Oil, cohune oil, macadamia nuts, cashews, peanuts, star anise seed oil, Mucajá nut or combinations thereof.

18. The method of claim 10, wherein the sugars and/or sugar replacement source is selected from monk fruit powder, Banana, maple syrup, Custard apple, Raisins, Durian, Pears, Prunes, Sapodilla, Agave, Dried apricots, Date palm, Mangosteen, Barhi dates or combinations thereof.

19. The method of claim 10, wherein the food product is a frozen dessert product, shredded cheese, milk and cream powder, flour-based mix, cocoa and mixed coffee beverage, frozen dough, and frozen noodles.

20. The method of claim 10, wherein physical characterization data associated with the ingredients of the anti-freezing and anti-caking system comprising the fat source, the fruit puree source, the lignin & cellulose source, the vegetable phytosterols & PUFA source, the PUFA & Omega-3-Fatty acid source, the Lauric acid source, and the sugars and/or sugar replacement source is stored in a database, wherein a machine learning model determines a unique combination of ingredients based on the physical characterization data to prepare the anti-freezing and anti-caking system.

21. The method of claim 10, wherein the physical characterization data of the ingredients comprise functional properties that comprise emulsification properties, stabilization properties, gelling properties, fat-replacement properties, Ayurvedic and/or other holistic properties, physicochemical properties that comprise pH, viscosity, moisture content, density, mechanical properties that comprise adhesive strength, tensile strength, shear resistance, chemical and/or molecular descriptor properties that comprise bio-active/bioavailability properties, molecular structure, phytonutrient properties, sensorial properties that comprise taste, smell, color, texture, mouth feel, and nutritional information that comprises macronutrient/micronutrient properties.
